(19) United States
(12) Patent Application Publication
(10) Pub. No.: US 2009/0182602 A1
(43) Pub. Date: Jul. 16, 2009

(54) HUMAN RESOURCES METHOD FOR EMPLOYEE DEMOGRAPHICS REPORTING COMPLIANCE

(75) Inventors: Steven C. Black, Snoqualmie, WA (US); John P. Boggs, Half Moon Bay, CA (US)

Correspondence Address: Workman Nydegger;1000 Eagle Gate Tower, 60 East South Temple, Salt Lake City, UT, 84111, US

(73) Assignee: HOTLINKHR, INC., Snoqualmie, WA (US)

(21) Appl. No.: 12/396,205

(22) Filed: Mar. 2, 2009

Related U.S. Application Data
(63) Continuation-in-part of application No. 10/848,809, filed on May 19, 2004.
(60) Provisional application No. 60/474,044, filed on May 29, 2003.

(51) Int. Cl. G06Q 10/00; G06Q 50/00

(52) U.S. Cl. 705/7

(57) ABSTRACT

In one example embodiment, a human resources method for employee demographics reporting compliance includes various acts. First, a server system sends, to a client system, one or more employee demographics reporting criteria. Next, the server system receives, from the client system, an indication that one or more employee demographics reporting criteria are satisfied. Then, the server system automatically determines that a report coordinator is not yet designated. Finally, the server system sends, to the client system, an indication that a report coordinator must be designated before an employee demographics report can be generated.

### CROSS-REFERENCE TO RELATED APPLICATIONS

The present application is a continuation in part of U.S. patent application Ser. No. 10/848,809, filed May 19, 2004, and entitled “AUTOMATED COMPLIANCE FOR HUMAN RESOURCE MANAGEMENT,” which claims priority from U.S. Provisional Patent Application Ser. No. 60/474,044, filed May 29, 2003, entitled “WEB BASED SYSTEMS AND METHODS FOR HUMAN RESOURCES COMPLIANCE MANAGEMENT.” Each of the foregoing applications is incorporated herein by reference in its entirety.

### BACKGROUND

Human resources managers and other personnel are presently faced with an increasingly complex, and frequently changing, web of human resources requirements (including rules, statutes, regulations and other guidelines) with which they must either comply, or else face potentially costly and time-consuming legal action. The ability of an employer, and its personnel, to fully and timely comply with the various human resources requirements that apply to human resources management is significantly affected by the complexity of those human resources requirements, as well as by the fact that legislation constantly changes the human resources requirements with which employers must comply. Employee turnover, retirement, training and other dynamic events also contribute to the number of processes that must be continually addressed by the human resources personnel.

In businesses characterized by high turnover, the human resources workload can be quite significant. In particular, a substantial amount of documentation is required to manage and track the transition of employees through the application, training and separation processes. One difficulty with managing human resources concerns the production and distribution of employee forms, particularly when it is necessary to ensure that forms have been updated according to the latest human resources requirements.

Changes in human resources requirements can create a further burden on human resources departments, even beyond the initial burden to establish and maintain awareness of the changes in the human resources requirements. In particular, changes in human resources requirements can also result in financial expenditures by an employer when that employer implements the training necessary for human resources personnel to learn the new human resources requirements. The acquisition of new forms by the employer, as well as updating the existing processes and procedures, may impose further expenses on the employer.

In these cases, as well as in cases where there is little change in employee turnover or the state of applicable human resources requirements, ensuring compliance with human resources requirements may be difficult to manage because ensuring compliance is often relegated to a relatively low position in terms of the priorities of the employer, either intentionally or accidentally. As explained above however, the failure of an employer to comply with the applicable human resources requirements can expose the employer to significant legal liability.

Nevertheless, despite the importance of compliance with human resources requirements, as well as the potentially significant costs and risks associated with non-compliance, many employers lack a method or process to systematically identify and address human resources issues implicated by the hiring, disciplining, separation, reporting, and other processes of the employer.

Yet another problem that plagues human resources departments concerns the need for compliance with employer-imposed or government-imposed employee demographics reporting requirements. For example, many human resources departments are required by applicable human resources requirements to comply with employee demographics reporting requirements of the Equal Employment Opportunity Commission (EEOC) of the U.S. Government. Determining whether an employer is required to report any demographics information at all, and gathering the demographics information required to be reported, can be burdensome for human resources departments. Adding to this burden is the sensitive nature of the demographics information that the EEOC requires to be reported. For example, demographics information may include the race, gender, ethnicity, religion and/or other highly sensitive and personal characteristics of each employees of an employer. The inherently sensitive and personal nature of demographics information can make gathering this information uncomfortable at best and expose the employer to legal liability at worst. In addition, a variety of factors influence whether a reporting requirement applies to a particular employer and what type of information must be reported. These factors, along with frequently evolving human resources requirements, can make compliance with employee demographics reporting requirements extremely burdensome for human resources personnel.

### SUMMARY OF SOME EXAMPLE EMBODIMENTS

In general, example embodiments of the invention relate to business methods and systems for managing human resources and, more particularly, for automating employee demographics reporting compliance with dynamic and static human resources requirements.

In one example embodiment, a human resources method for employee demographics reporting compliance includes various acts. First, a server system sends, to a client system, one or more employee demographics reporting criteria. Next, the server system receives, from the client system, an indication that one or more employee demographics reporting criteria are satisfied. Then, the server system automatically determines that a report coordinator is not yet designated. Finally, the server system sends, to the client system, an indication that a report coordinator must be designated before an employee demographics report can be generated.

In another example embodiment, a human resources method for employee demographics reporting compliance includes various acts. First, a server system sends, to a client system, one or more employee demographics reporting criteria. Next, the server system receives, from the client system, an indication that one or more employee demographics reporting criteria are satisfied. Then, the server system automatically determines that an employee demographics report has not yet been filed. Next, the server system sends, to the client system, an indication that an employee demographics report must be filed.

In yet another example embodiment, a human resources method for employee demographics reporting compliance includes various acts. First, a server system receives, from a first client system, one or more demographics of a first employee. Next, the server system receives, from a second client system, one or more demographics of a second employee. Then, the server system automatically generates an employee demographics report comprising the one or more demographics of the first and second employees. Next, the server system sends, to a third client system, the employee demographics report.

In still another example embodiment, a human resources method for employee demographics reporting compliance includes various acts. First, a server system receives, from a first client system, an indication that an employee has declined to identify one or more demographics of the employee. Next, the server system sends, to a second client system, an indication that the employee has declined to identify one or more demographics of the employee. Then, the server system receives, from the second client system, one or more demographics of the employee. Next, the server system automatically generates an employee demographics report comprising the one or more demographics of the employee. Then, the server system sends, to the second client system, the employee demographics report.

In yet another example embodiment, a human resources method for employee demographics reporting compliance includes various acts. First, a client system receives, from a server system, one or more employee demographics reporting criteria. Next, the client system determines that one or more of the employee demographics reporting criteria is satisfied. Then, the client system sends, to the server system, an indication that one or more employee demographics reporting criteria is satisfied.

### BRIEF DESCRIPTION OF THE DRAWINGS

To further clarify certain aspects of example embodiments of the invention, a more particular description of the invention will be rendered by reference to example embodiments thereof which are disclosed in the appended drawings. It is appreciated that these drawings depict only example embodiments of the invention and are therefore not to be considered limiting of its scope nor are they necessarily drawn to scale. Aspects of example embodiments of the invention will be described and explained with additional specificity and detail through the use of the accompanying drawings in which:

FIG. 1 discloses an embodiment of a network environment in which client systems can communicate with a server system that may be configured to leverage third party resources;

FIG. 2 is a flowchart of an example method for managing human resources compliance involving employee forms that are generated and updated for an employer and that are presented to the employer in an appropriate order;

FIG. 3 is a flowchart of a first example method for employee demographics reporting compliance;

FIG. 4 is a flowchart of a second example method for employee demographics reporting compliance;

FIG. 5 is a flowchart of a third example method for employee demographics reporting compliance;

FIG. 6 is a flowchart of a fourth example method for employee demographics reporting compliance;

FIGS. 7-20 are directed to various displays such as might be presented to a user by way of an example Equal Employment Opportunity Commission module graphical user interface; and

FIGS. 21 and 22 are two pages of an example employee demographics report.

### DETAILED DESCRIPTION OF SOME EXAMPLE EMBODIMENTS

Example embodiments of the invention relate to business methods and systems for managing human resources and, more particularly, for automating employee demographics reporting compliance with dynamic and static human resources requirements.

Embodiments of the invention may take the form of various software applications that facilitate the management of human resources and help to drive, and ensure, compliance with human resources requirements. As used herein, the term “human resources requirements” refers to statutes, rules, regulations, and other guidelines of governments (e.g., federal, state, and/or local governments) and governmental agencies, as well as employer specific policies and practices in areas such as, but not limited to, hiring practices, employee training, employee transfers, employee separation, and employee demographics reporting requirements. Embodiments of the invention can be employed in any type of industry or business. Though embodiments of the invention may be particularly advantageous in relatively high-turnover businesses, even relatively low-turnover businesses can benefit from embodiments of the invention.

Embodiments of the invention can include special purpose and general-purpose computing devices having various computer hardware and software. Embodiments within the scope of the present invention can also include computer-readable media for carrying or having computer-executable instructions or data structures stored thereon. Computer-executable instructions comprise, for example, instructions and data which cause a general purpose computer, special purpose computer, or special purpose processing device to perform a certain function or group of functions.

Computer-readable media, on the other hand, can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means or modules in the form of computer-executable instructions or data structures and which can be accessed by a general purpose or special purpose computer.

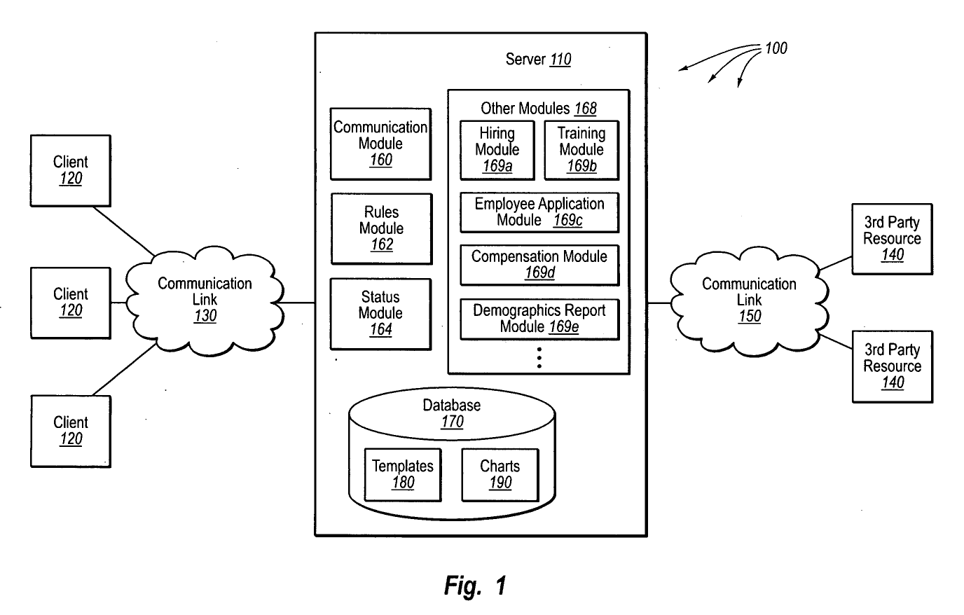

When information is transferred or provided over a network connection (either hardwired, optical, wireless, or a combination of hardwired, optical and/or wireless including IR and RF connections) to a computer, the computer also views the network connection as a computer-readable medium. Combinations of the above should also be included within the scope of computer-readable media. Accordingly, communication links 130 and 150, described below in reference to FIG. 1 can also be considered computer-readable media.

### 1. Example Network Environment

Attention will now be directed to FIG. 1, which illustrates a network environment 100 in which example embodiments of the invention can be practiced. As shown, a server system 110 is connected with one or more client systems 120 through a communication link 130. The communication link 130 can be any network connection. According to one embodiment, the communication link includes a LAN, a WAN, and/or the Internet, such that the one or more client systems 120 can access the server system 110 through a LAN, a WAN, and/or the Internet.

The server system 110 is also shown to be connected with one or more third party resources 140 through a suitable communication link or links 150. The third party resources 140 can include any combination of computing devices, software, and network systems. According to one embodiment, the third party resources can include repositories of human resources requirements, as well as agencies, such as investigative agencies that can be used to perform and/or report the results of a background check or screening process. Third party resources can also comprise such things as labor insurance, health insurance and safety program providers.

In other embodiments, the client system(s) 120 are also configured to communicate directly with the third party resource(s) 140 through a suitable communication link. In such embodiments, the server system 110 can still provide useful functionality by facilitating compliance with existing human resources requirements and for instructing the client system(s) 120 how and when it is appropriate to contact the third party resource(s) 140.

As shown, the server system 110 includes various modules (160, 162, 164, and 168) and a database 170 that can be used to help manage human resources compliance at the client systems 120.

Each of the illustrated modules (160, 162, 164, 168), although described as corresponding to a particular subject area, also includes the ability to communicate with, and operate in connection with, one or more of the other modules. For example, data or results outputs from one module may comprise inputs to one or more other modules. Moreover, alternative or additional functional modules 168 can be incorporated into the system as necessary to suit changing needs and requirements. In addition, the functionalities disclosed herein may be allocated in various ways among the functional modules (160, 162, 164, 168) and/or between the server system 110 and one or more client systems 120. Accordingly, the allocation of functionalities disclosed herein is exemplary only and is not intended to limit the scope of the invention in any way.

The first illustrated module, the communication module 160, is configured with suitable computer-executable instructions for enabling the server system 110 to communicate with the client systems 120 and the third party resources 140. Accordingly, the communications module 160 can include both hardwired, wireless, and/or optical communications components to enable communication over hardwired networks, as well as optical and/or wireless networks. The communication module 160 can also include any other components that may be necessary to enable communication between the server system 110 and the client systems 120 and third party resources 140, including, but not limited to, OCR (optical character recognition), voice recognition and translation components.

The communications module 160 also includes functionality for authenticating and authorizing the client system 120 access to information stored by the server system 110, as well as for encrypting data transmissions. According to one embodiment, the communications module 160 also includes functionality for enabling and authenticating digital signatures of employers and employees, which may be required to verify requested consent and approval, and/or to execute a legal document.

The rules module 162 includes computer-executable instructions for managing and tracking the human resources requirements that are to be complied with by the client systems 120. According to one embodiment, the rules module 162 is configured to query one or more third party resources 140 to determine the current human resources requirements regarding a particular process. The rules module 162 can also include corresponding calendaring functionality for determining a suitable time to initiate a query for updates in the human resources requirements, such as, for example, based on a predetermined period of time or occurrence or non-occurrence of an event.

In other embodiments, the rules module 162 is configured to passively receive input regarding human resources requirements with which the client systems 120 are to comply. The rules module 162 tracks the current state of the human resources requirements in a chart 190, table and/or other data structures within the server database 170. The rules module 162 may be configured to actively pull current human resources requirements from one or more third party resources 140 and/or one or more of the third party resources 140 may be configured to actively push current human resources requirements to the rules module 162. The client systems 120 can pull, and/or have pushed to them, the human resources requirements from the rules module 162. More generally, any of the modules or systems of system 100 of FIG. 1 can actively pull information, and/or have information actively pushed to them, from another system/module.

Changes in human resources requirements that are received by the rules module 162 can then be incorporated into the templates 180 and employer human resources processes that are managed by the server system 110. The templates 180 are pre-existing forms that include standard text as well as blank fields into which employer-specific custom text can be inserted. It will be appreciated that while some changes in human resources requirements can be implemented automatically by the server system, others may require a system administrator to manually implement the change.

The rules module 162 also includes the functionality to track and report the progress of a client system 120 through a particular human resources process such as, but not limited to, hiring an employee, training an employee, or compensating an employee, reporting demographics about an employee, and to determine whether the client system 120 is complying with, or overriding, a prescribed sequence for advancing through each process. For example, in some example embodiments the client system is allowed some leeway to override a prescribed sequence, while in other example embodiments, the client system is forced to comply with a prescribed sequence.

The rules module 162 can also function to track and comply with human resources requirements related to privacy and to ensure that the information that is received from the client systems 120 is not shared or used by the server system 110 in violation of the privacy requirements related to human resources information.

The status module 164 is configured to monitor, track, and report on the status of employer applicants, employees, and other employer objects that are involved in a human resources process. The status module 164 is also configured to monitor, track, and report on the progress of employer applicants, employees, and other employer objects through a human resources process. The status module 164 also includes the functionality to query for information regarding a particular employer object. For example, the status module 164 might utilize the communication module 160 to initiate a background check by a third party resource 140 of a prospective employee, or of a current employee. The status module 164 might further utilize the communication module 160 to determine whether an applicant has submitted a requested piece of information. The status module 164 might then generate a report that is sent to one of the client systems 120 with the requested piece of information. Alternatively, or additionally, the status module 164 may generate a report that is stored on the server system 110 or sent to one of the third party resources 140.

The status module 164 can also obtain relevant status information from various sources, including the templates 180 that are submitted by the client system 120 or that are otherwise provided by the server system 110 to the client system 120. The status data of employers can be tracked within the charts 190 and other data structures of the server database 170. The term “status data,” should not be construed narrowly. Instead, “status data” should be broadly construed to include any information corresponding to the employer or employer parties, such as, but not limited to, personalized information (e.g., name, address, birthday, demographics such as race, gender, etc.), as well as professional information (e.g., experience, title, position, compensation, etc.). Status data can also be directed to a particular human resources process, such as application status (e.g., complete/incomplete), interview status (e.g., passed/failed), screening status (e.g., passed/failed), offer status (e.g., conditional/accepted/rejected), and so forth.

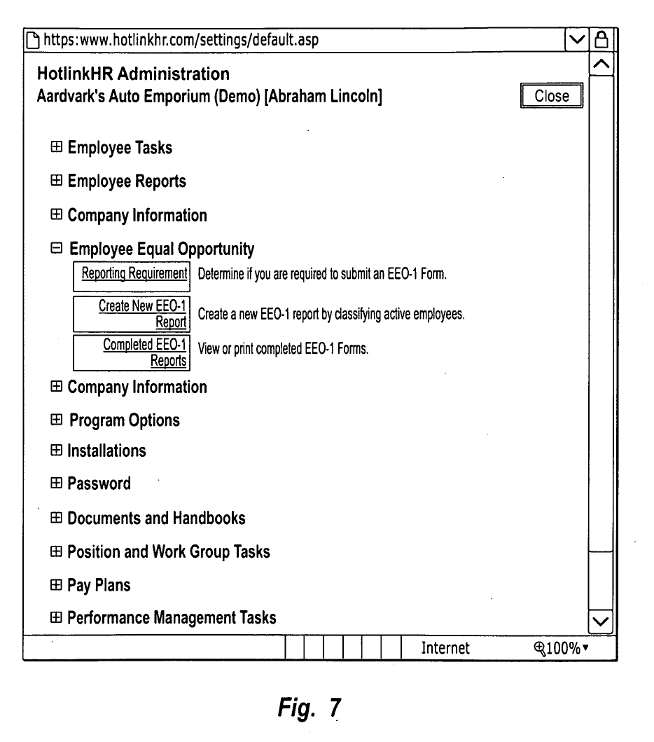

Other modules 168, some of which are described in more detail below, such as the hiring module 169a, the training module 169b, the employee application module 169c, the compensation module 169d, and the demographics report module 169e are configured with computer-executable instructions for facilitating compliance with various human resources requirements, as disclosed herein. Additional aspects of example displays of the demographics report module 169e are disclosed below in connection with FIGS. 7-20.

The server database 170 is currently shown to be incorporated within the server system 110. Nevertheless, it will be appreciated that the database 170 can include remote data storage as well as local data storage. Likewise, it will also be appreciated that the database 170 can include any combination or quantity of computer-readable media, including, but not limited to RAM, ROM, EEPROM, CD-ROM, other optical disk storage, magnetic disk storage and magnetic storage devices. The database 170 may include a variety of different data structures including, but not limited to lists, associative arrays, and tree data structures. The database 170 may further comprise software, dedicated hardware, or a combination of software and dedicated hardware.

### 2. Methods for Managing Human Resources Compliance

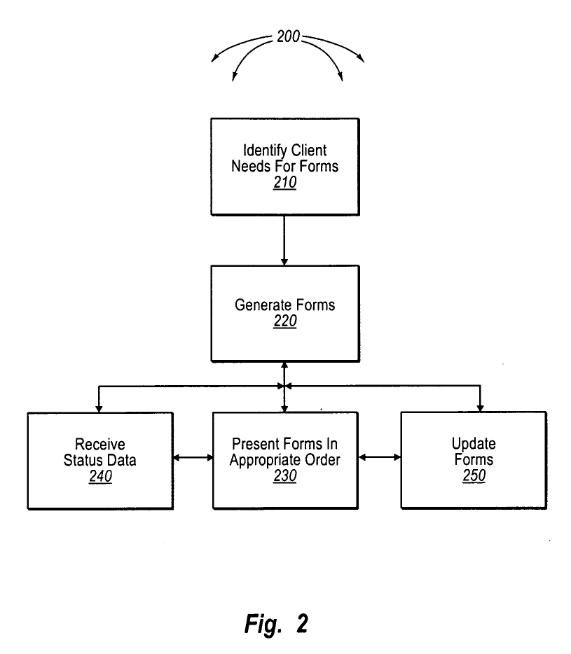

Attention will now be directed to FIG. 2, which illustrates a flowchart 200 of one embodiment of a method for managing human resources compliance. As shown, the method begins with the act of a server system identifying employer needs for forms (act 210). The act 210 may at least partially rely on previously gathered information about the employer such as, but not limited to, the employer's industry, number of employees, or type of employees. The terms “form” and “human resources form” should be broadly construed to include any employee form, template, report, document, manual, or other material that can be used to implement a human resources process. Non-limiting examples of forms include applications, authorizations, requests, disclosures, instruction materials, reports, and training materials.

The act of identifying an employer need for a form (act 210) can be accomplished directly, by receiving an explicit request from an employer, or indirectly, by determining that an employer needs a form based on an evaluation of employer characteristics and based on human resources requirements that require a form for implementation of a particular process by the employer. For example, the act 210 may include determining that an employer needs an employee demographic form based on the number of employees employed by the employer and based on a federal government statute that requires the employee demographics form. The identification of an employer need for a form (act 210) can also include identifying a change in a human resources requirements or the employer status that requires a form to be updated or produced for that employer.

The appropriate forms are then generated by the server system for the employer (act 220). According to one embodiment, the generated forms are customized for each employer according to the available status information that is currently known about the employer and according to the existing human resources requirements. For example, if different forms are required for different sized employers, different employer types, and/or different employee types (such as exempt, non-exempt, part-time, full-time, permanent, or seasonal), the server system generates the appropriate form for that employer.

Likewise, the generation of forms (act 220) can also include the auto-completing, or auto-population, of the forms with data that is presently known by the server system or that is automatically obtained in response to a query. For example, if a form has fields that need to be completed by the employer or employee, that information can be automatically input into the fields on the form when the requested data is already known. In addition, if a form has fields that should not be changed, those fields can be locked so that they are not inadvertently or purposely modified by the employer or employee.

Thereafter, the forms can be presented by the server system to the employer for their intended purpose, and in compliance with the human resources requirements governing the employer process (act 230). For example, if an employer needs to submit a form to a government agency, that form can be produced and presented to the employer for completion. This presentation can be accomplished by displaying the form on a client system display or by automatically printing the form on a client system printer. Of course, printing the form may not be necessary in some circumstances, such as where a form is filed electronically with a government agency, for example. Alternatively, if enough information is known about the employer to complete the form, it can be auto-completed and submitted to the employer for final approval. Thereafter, the employer can submit the form to the appropriate agency. The employer may also authorize the server system to submit the form, in which case the employer can digitally sign the document, as suggested above. The employer may also store completed or partially completed forms, such as on one of the client systems 120 or in the database 170 of the server system 110 (see FIG. 1).

One benefit provided by example embodiments of the present invention is that these embodiments not only enable the creation of forms and information for an employer that are compliant with the existing human resources requirements, but these embodiments also determine the appropriate order in which the forms and information should be presented, so as to further facilitate compliance with human resources requirements. For example, if an employer cannot legally identify an employee's demographics until the employer first provides an opportunity to the employee to self-identify his own demographics, then the server system will determine this, based on the existing human resources requirements for example, and will dynamically provide the employer the opportunity to identify the employee's demographics only after the system has verified that the employee has been given an opportunity by the server system to self-identify his own demographics.

Many of the employer forms generated by the server system will request status data about the employer or employer parties (e.g., applicants/employees). In one embodiment, status data is received (act 240) at the server system in direct response to a query for information when an employer or employer party completes and submits a form to the server system. For example, when an employee self-identifies his own demographics, either online (e.g., via a server website) or by paper, and submits the demographics to the server system (e.g., having it scanned by a client system and submitted to the server system), the server system receives the demographics (act 240) and stores the demographics for future use. Status data can also be obtained automatically when the server system, for example, queries a database or system associated with the employer, without requiring the employer to expressly or manually fill out a form or respond to a specific request. Status data about an employer or employer party can alternatively be obtained indirectly through a remote third party resource, such as an investigative agency, credit bureau, and so forth.

Whenever status data is received (act 240) and whenever the current human resources requirements have changed, there is the possibility that the forms produced for the employer either need to be updated (act 250) or reordered and presented in an appropriate order (act 230) to accommodate the change(s). Updating forms can include adding new forms, modifying forms, or deleting forms.

Accordingly, in one embodiment of the invention, the forms are dynamically updated to accommodate changes in human resources requirements. For example, if a change in human resources requirements prohibits an employer from requesting certain information, the rules module 162 will automatically determine whether the change in human resources requirements created a conflict or inconsistency with any existing forms. If there is a conflict between a change in human resources requirements and an existing form, the form will automatically be changed to accommodate the new human resources requirements. For example, in the present case, the prohibited request for information would be stricken from any existing forms so that the employer would only be presented with forms that are compliant with the current human resources requirements. Where a form that has been partially completed requires a change to accommodate new human resources requirements, the partially completed form may be updated and retain the partially complete data to the extent that the data remains relevant, or the partially completed form may be deleted and the employer may be notified that the partially completed form has been changed and must be redone.

According to some embodiments, the order in which forms are presented to the employer will also change dynamically to accommodate changes in the human resources requirements and/or status data received from the employer. For example, if a change in human resources requirements included a provision requiring an employee to be given the opportunity to self-identify his own demographics, the server system would automatically generate a request for demographics from the employee with a corresponding data structure for tracking the employee's response to the request.

In some embodiments, notices regarding changes in human resources requirements are also generated (e.g., via email or banners) to advise the employer of the recent changes and to instruct the employer of the steps that should be taken to remain compliant with the new human resources requirements. This may require the employer to repeat certain steps that have already been performed, such as filling out forms, after the forms have been updated. This functionality can be particularly useful when considering that a change in human resources requirements can occur ‘mid-stream,’ after a human resources process has already begun, but prior to its completion.

The request for demographics could also be customized for each employee, depending on the needs of the employer, and could be presented in an electronic format through the Internet or other network, thereby eliminating the need for the employer to expend the time and cost associated with requesting the demographics from the employee in a face-to-face conversation and ensuring that that the request is made in a legally compliant manner.

It will be appreciated that in this manner, it is possible to reduce or eliminate the need for employer human resources departments to individually monitor and track certain processes. Instead, the employer can rely on the server system to effectively implement and monitor disclosure and certain other human resources processes, and to notify the employer about various employer actions that need to be taken. The server system also can handle recordkeeping, or can assist the employer in doing so.

In each of the forgoing and following examples, a user interface can also be provided to facilitate access to various forms and materials. Access to different data through the interface can also be controlled according to different authorization levels to accommodate virtually any need and preference. The user interface can be presented to the employer in various ways. For example, the user interface can be provided to the employer through a browser-based application and webpage as well as through direct access.

According to one embodiment, the user interface generally provides access to forms corresponding to different human resources processes. Access to the forms is controlled at least in part by the human resources requirements governing the human resources process, as well as the needs of the employer. For example, the user interface can restrict an employer from accessing a particular form until employer status data (e.g., form data) is received and/or until human resources requirements for submitting the form has been satisfied (e.g., providing an opportunity for an employee to self-identify demographics before an employer manager is allowed to identify demographics for the employee). In this way, the server system drives and controls human resources processes to ensure that these processes are compliant with human resources requirements.

By way of illustration, and not limitation, the user interface can provide checklists that need to be manually checked off by a user before the user is allowed to advance to a different screen of the interface or prior to receiving a desired form. In such circumstances, the checklists may require input (e.g., employer status data) that indicates a particular task has been completed or that provides a requisite piece of information.

Typically, the user interface presents the forms that are being requested by the employer, and at the time they are requested. However, as described above, the availability of the forms, as well as the sequence in which they are provided, may be contingent upon employer compliance with human resources requirements. Upon receiving employer input that is implicitly or explicitly requested by the form, the user interface then proceeds to obtain and display, in the appropriate order, additional forms to be used by the employer. For example, the additional forms may include training manuals, hiring packets, or other materials that are customized for a particular process. Customization can be performed, for example, by using the status data and input received from the employer.

In some embodiments, the user interface also includes a portion dedicated to highlighting recent changes in the human resources requirements that are used to govern the human resources processes. This way, the employer can be apprised of relevant changes in human resources requirements even though the employer may not be involved in the particular stage of a process that is currently being affected by the change in the human resources requirements. The interface can also be used as a medium for requesting and receiving information from the employer that can be used to generate or customize a form.

In some embodiments, the interface also provides portions dedicated to enabling the employer to generate and/or query tables, charts, reports, and spreadsheets indexing the status date corresponding to the employer, the human resources requirements corresponding to a human resources process, and status data corresponding to the applicants and employees of the employer.

In certain embodiments, as described above, applicants and employees of the employer can also obtain limited access to the interface to undergo training, review the current human resources requirements of particular processes, access manuals and handbooks, fill out forms, request information, digitally sign documents, and to review their status information.

With general reference to one example application of the invention, the user interface can also be used to guide an auto dealer through various step-by-step processes that assure full and timely compliance of the auto dealer with human resources requirements in areas such as, but not limited to, applications for employment, hiring, new hires, employee training, employee discipline, employee separation, retirement, employee demographics reporting, and employer policies. The scope of the example embodiments disclosed herein are not limited to this application, but can be applied to any application that requires functionality disclosed herein.

### 3. Managing Employee Demographics Reporting Compliance

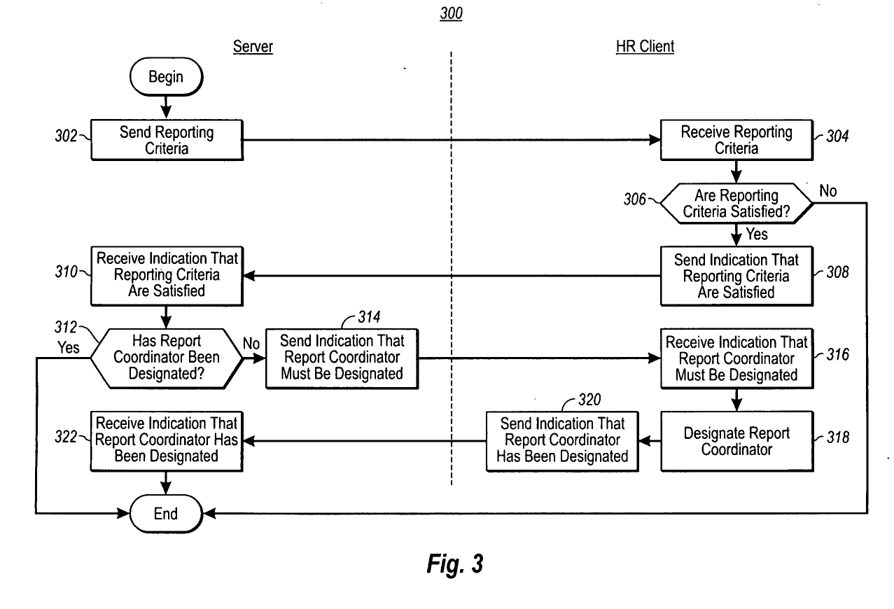

FIGS. 3-6, which will now be discussed, are flowcharts of example methods 300, 400, 500, and 600 for an employer to use in complying with employee demographics reporting requirements. Embodiments of the example methods 300-600 will also be described with reference to FIG. 1.

### 4. First Example Method

With particular reference now to FIG. 3, additional details regarding the example method 300 for employee demographics reporting compliance will be disclosed. The example method 300 may, for example, assist an employer in determining whether the employer is required to file an employee demographics report, and in determining whether an employee has been designated as the coordinator for the generating and filing of the report.

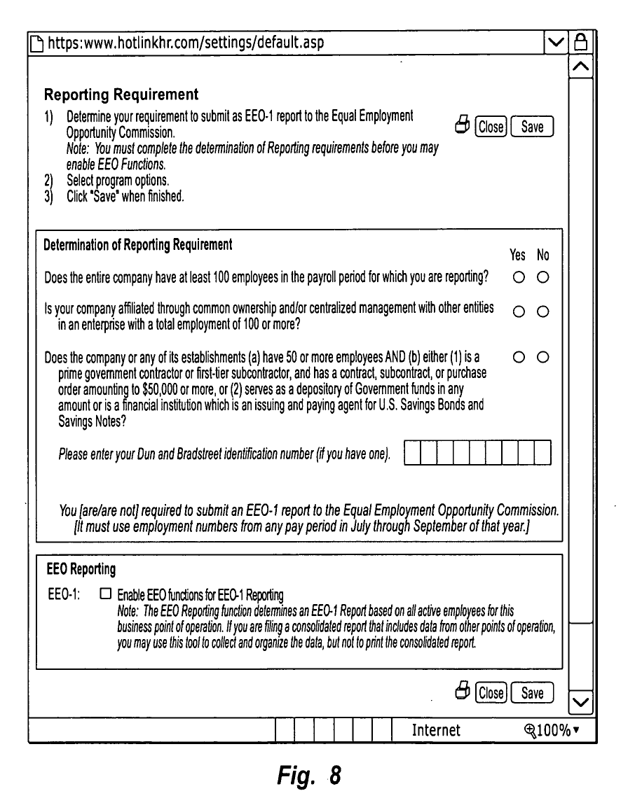

The method 300 begins with a server system sending employee demographics reporting criteria to an employer client system (act 302) and the demographics reporting criteria being received at the employer client system (act 304). For example, at act 302, the demographics report module 169e (FIG. 1) of the server system 110 can send employee demographics reporting criteria to one of the client systems 120. The demographics report module 169e may send this employee demographics reporting criteria in response to a user selecting the “Reporting Requirement” link on the example display of FIG. 7. Upon reception of the employee demographics reporting criteria at act 304, the client system 120 can display the employee demographics reporting criteria to a user, as disclosed in the example display of FIG. 8.

Similar to the example display of FIG. 8, the reporting criteria may include questions such as:
1) Does the entire employer have at least 100 employees in the payroll period for which you are reporting?
2) Is your employer affiliated through common ownership and/or centralized management with other entities in an enterprise with a total employment of 100 or more?
3) Does the employer or any of its establishments (a) have 50 or more employees AND (b) either (1) is a prime government contractor or first-tier subcontractor, and has a contract, subcontract, or purchase order amounting to $50,000 or more, or (2) serves as a depository of Government funds in any amount or is a financial institution which is an issuing and paying agent for U.S. Savings Bonds and Savings Notes?

Continuing with the method 300, the employer client system next determines whether the employee demographics reporting criteria are satisfied (act 306). It is understood that, in some embodiments at least, the reporting criteria are satisfied if only one of the criteria is true, but is also satisfied if two of the criteria are true or all three of the criteria are true. The act 306 can be accomplished, for example, by determining whether one, two, or three of the “Yes” radio buttons were selected by a user on the example display of FIG. 8. If the reporting criteria are not satisfied, the method 300 terminates. If, however, the reporting criteria are satisfied, then the employer client system sends the server system an indication that the reporting criteria are satisfied (act 308), and the server system then receives the indication (act 310). The act 308 can be accomplished in response to a user selecting one of the “Yes” radio buttons and then selecting the “Save” button on the example display of FIG. 8.

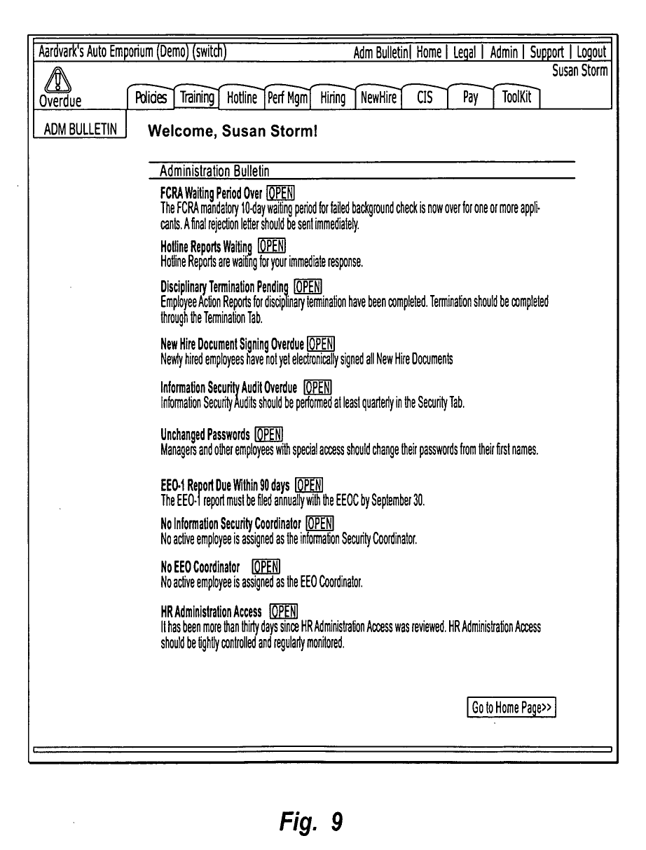

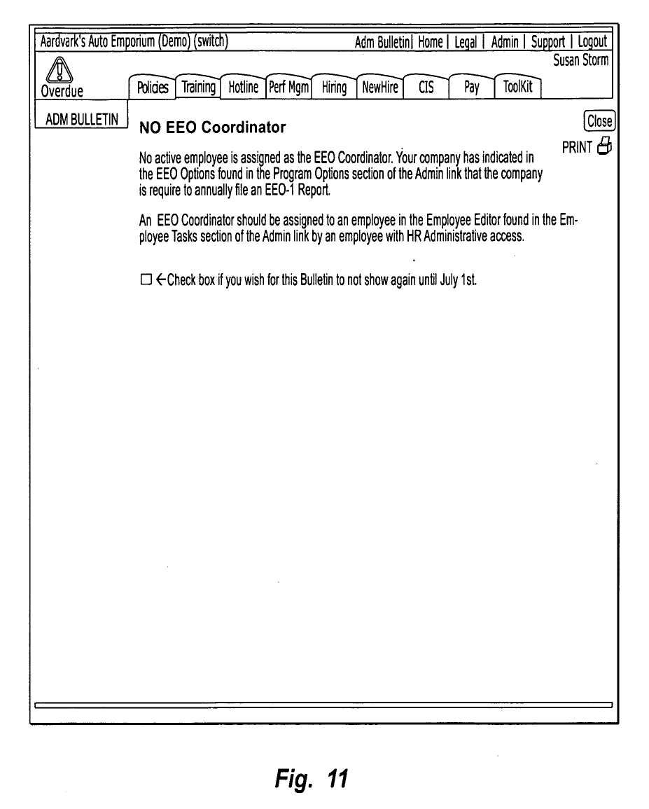

Continuing with the method 300, the server system next determines whether a report coordinator has been designated (act 312). For example, the demographics report module 169e may determine whether any employee has been designated as a report coordinator responsible for the generation of an employee demographics report. If a report coordinator has been designated, the method 300 terminates. If, however, a report coordinator has not been designated, then the server system sends an indication (act 314) to the employer client system that a report coordinator must be designated prior to the generation of an employee demographics report and the employer client system receives the indication (act 316). The employer client system can then display this indication, for example, as disclosed on the example displays of FIGS. 9 and 11.

Continuing with the method 300, a report coordinator is next designated at the employer client system (act 318). For example, this designation may be made in response to a selection by a user of one or more employees as report coordinators at one of the client systems 120. The employer client system then sends an indication that a report coordinator has been designated (act 320) and the indication is received at the server system (act 322), at which point the method 300 terminates. For example, one of the client systems 120 can notify the demographics report module 169e that a report coordinator has been designated. This notification may also entail notifying the demographics report module 169e which employee or employees have been designated as report coordinator(s), including the name(s) and contact information of the employee(s).

Thus, the example method 300 disclosed herein may facilitate the determination that an employee demographics report is required, and may facilitate the identification of a report coordinator responsible for the generation and filing of the report.

### 5. Second Example Method

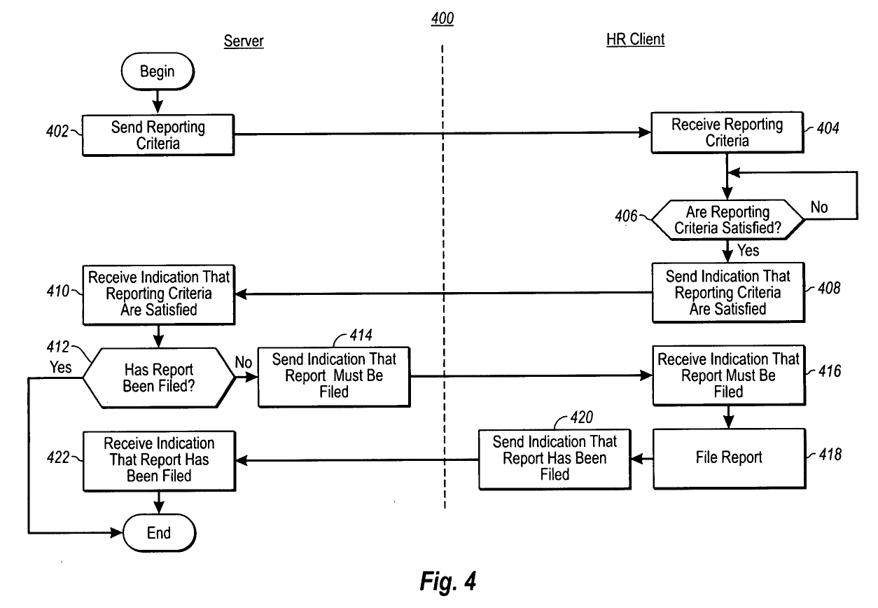

With particular reference now to FIG. 4, additional details regarding the example method 400 for employee demographics reporting compliance will be disclosed. The example method 400 may assist, for example, a human resources administrator of an employer in determining whether the employer is required to file an employee demographics report, and in determining whether the employee demographics report has been filed.

The method 400 begins with acts 402-410, which may be substantially the same as the acts 302-310 of the method 300. After the act 410 has been performed, the server system determines whether an employee demographics report has been filed (act 412). For example, the demographics report module 169e may determine whether an employee demographics report has been filed for the employer in the current reporting compliance period. If a correct and complete employee demographics report has been filed, the method 400 terminates. For example, a client system 120 may have electronically submitted an employee demographics report to a third party resource 140 corresponding to an appropriate government agency. Alternatively, a client system 120 may have authorized the server system 110 to electronically submit an employee demographics report, in which case the employer may have digitally signed the report, as suggested above. Alternatively, an employer may have manually submitted an employee demographics report through the mail, for example.

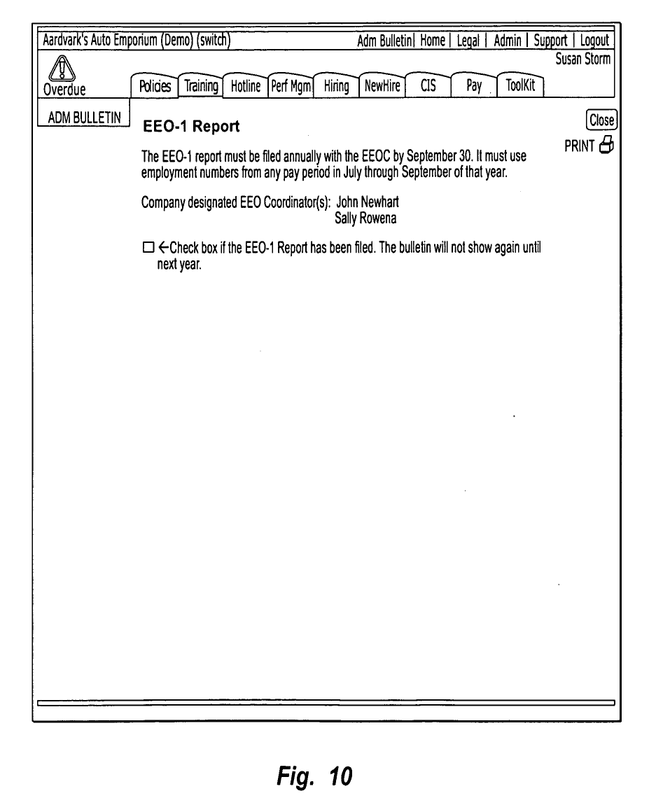

If, however, an employee demographics report has not been filed, then the server system sends an indication to the employer client system that an employee demographics report must be filed (act 414) in the current reporting compliance period and the employer client system receives this indication (act 416). The indication may further include a specific date by which the employee demographics report must be filed. The employer client system can then display this indication, for example, as disclosed on the example displays of FIGS. 9 and 10.

Continuing with the method 400, an employee demographics report is filed at the employer client system (act 418). For example, the employee demographics report may be filed by the employer, by the client system 120, or by the server system 110, as disclosed elsewhere herein. This filing of the employee demographics report may be determined when a human resources administrator checks the checkbox on the example display of FIG. 10. The employer client system then sends the server system an indication that the employee demographics report has been filed (act 420) and the indication is received at the server system (act 422), at which point the method 400 terminates. For example, one of the client systems 120 can notify the demographics report module 169e that an employee demographics report has been filed.

Thus, the example method 400 disclosed herein may facilitate the determination that an employee demographics report is required, and the determination that an employee demographics report has been filed for a particular reporting compliance period.

### 6. Third Example Method

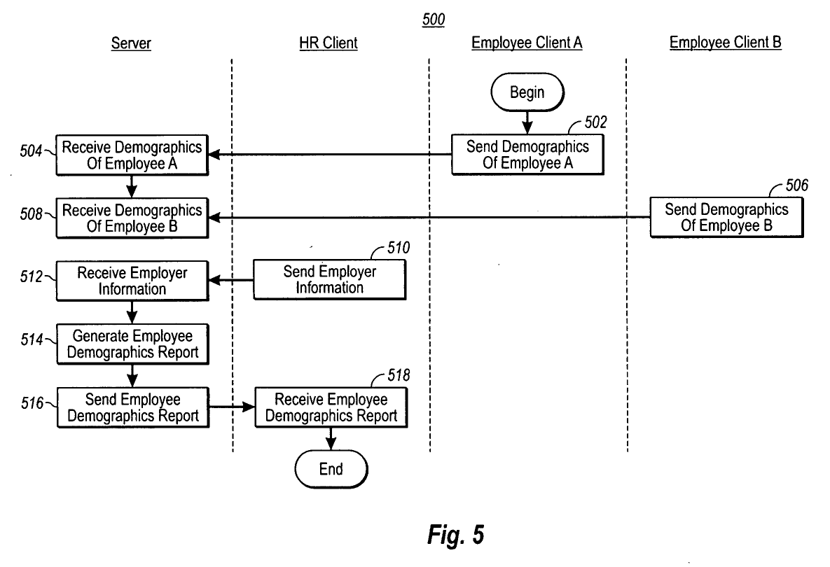

With particular reference now to FIG. 5, additional details regarding the example method 500 for employee demographics reporting compliance will be disclosed. The example method 500 may assist, for example, a human resources administrator of an employer in gathering data and automatically generating an employee demographics report.

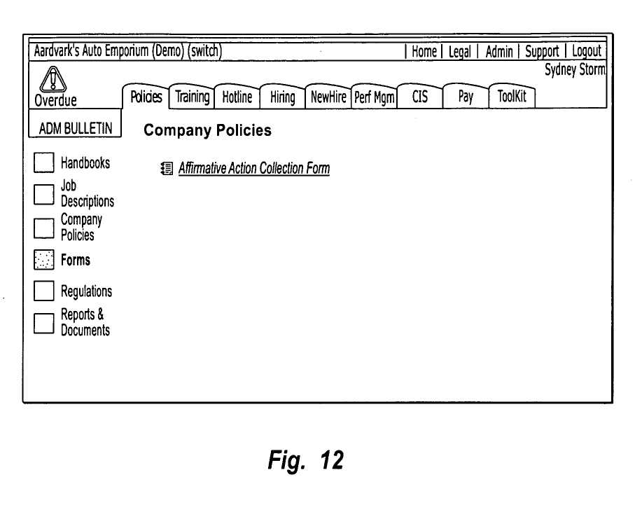

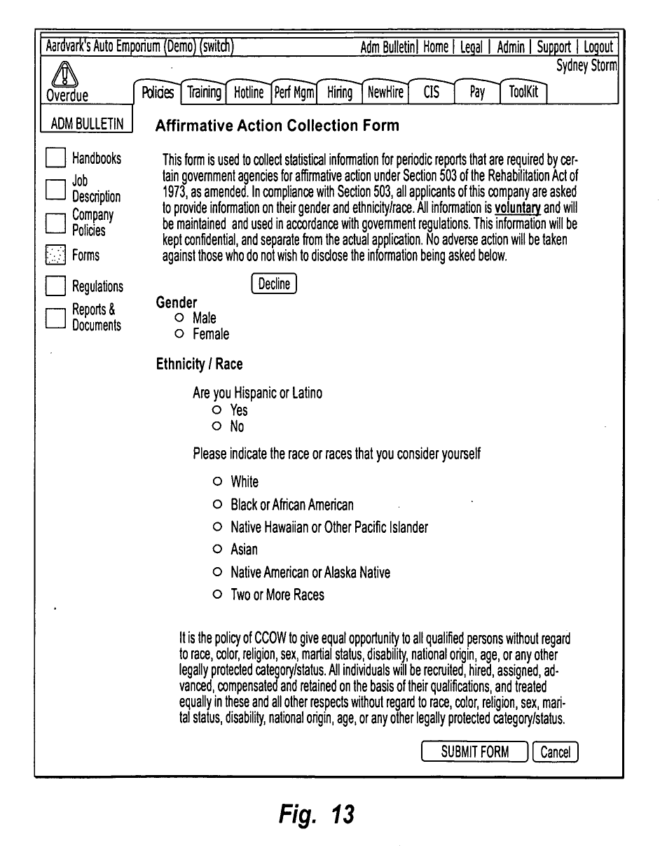

The method 500 begins with an employee A client system sending demographics of an employee A to the server system (act 502) and the demographics being received at the server system (act 504). For example, at act 502, one of the client systems 120 can send demographics of a first employee to the demographics report module 169e of the server system 110. These demographics can be entered by an employee using the example display of FIG. 13, which the user may access by selecting the ‘Affirmative Action Collection Form’ link of the example display of FIG. 12. As disclosed in FIG. 13, the employee demographics may include, but are not limited to, employee gender, employee race, and/or employee ethnicity.

An employee B client system next sends demographics of an employee B to the server system (act 506) and the demographics are received at the server system (act 508). Acts 506 and 508 may be accomplished similar to the acts 502 and 504, respectively.

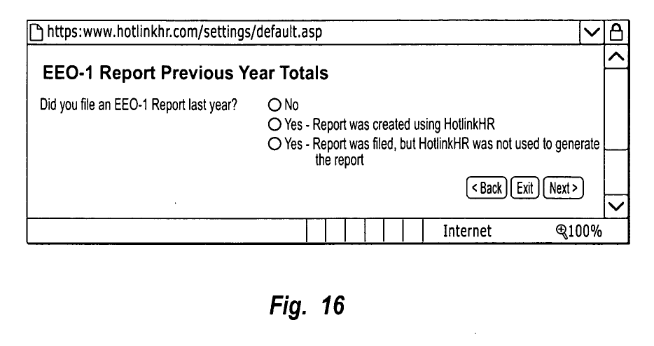

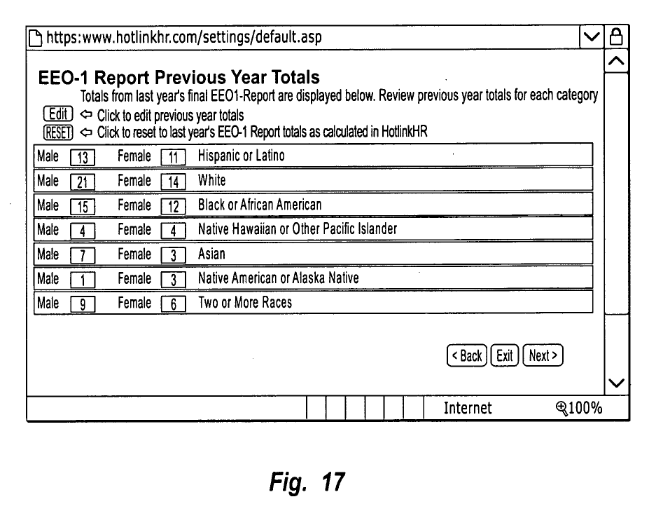

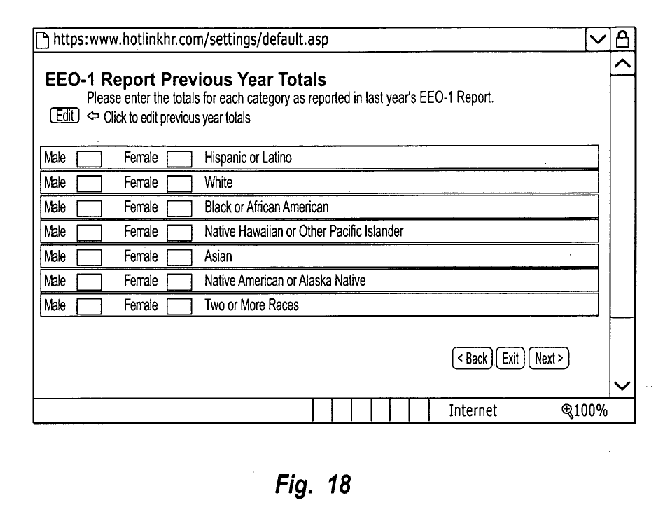

Alternatively, a human resources administrator of an employer may utilize information from previous reports to generate a new report. For example, utilizing the example display of FIG. 16, a human resources administrator can send an indication to the demographics report module 169e that a report was filed in a previous year. By selecting the ‘Yes—Report was created using HotlinkHR’ radio button and the ‘Next’ button of the display of FIG. 16, the display of FIG. 17 may be displayed to the administrator and allow the administrator to view and/or edit the totals from the previous year. By selecting the ‘Yes—Report was filed, but HotlinkHR was not used to generate the report’ radio button and the ‘Next’ button of the display of FIG. 16, the display of FIG. 18 may be displayed to the administrator and allow the administrator to enter the totals from the previous year. If the administrator selects the ‘Next’ button before filling in all totals, an error message may be displayed to the administrator. For example, the error message may read ‘You should fill in all totals from last years report. If you proceed, you report will not include last year's totals. Are you sure you wish to proceed?’ and include ‘Yes’ and ‘No’ buttons from which the administrator may select.

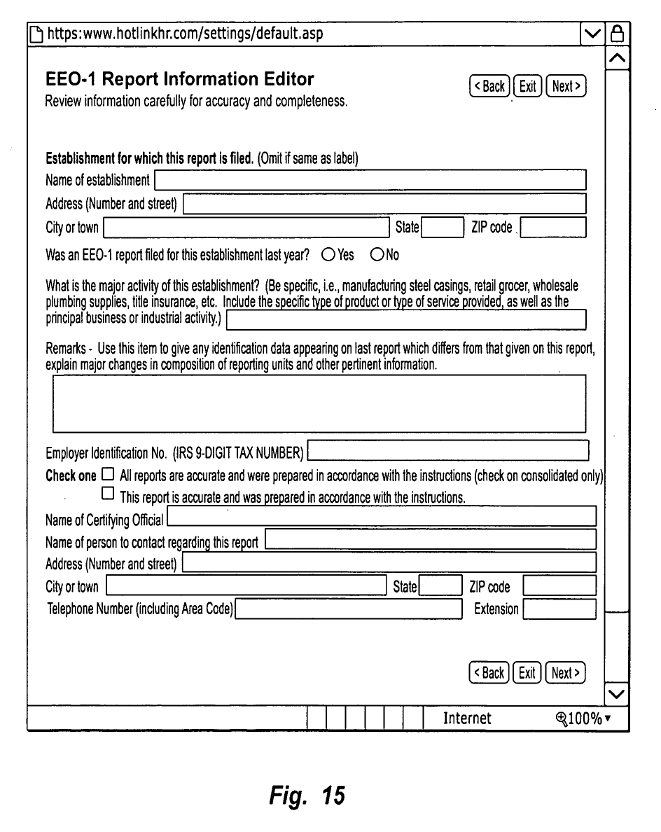

Continuing with the method 500, an employer client system may next optionally send employer information to the server system (act 510) and the information is received at the server system (act 512). For example, one of the client systems 120 may send information regarding the employer to the demographics report module 169e. This employer information may be input by a report coordinator using the example display of FIG. 15. As disclosed in FIG. 15, this employer information may include, but is not limited to, employer name, employer address, whether an employee demographics report was filed by the employer in the previous reporting compliance period, the employer business, an employer identification number, employee to contact regarding employee demographics report, address of employee to contact regarding employee demographics report, and/or telephone number of employee to contact regarding employee demographics report. After the employer information is input into the example display of FIG. 15, this employer information may then be sent by one of the client systems 120 to the demographics report module 169e.

Alternatively, the employer information may instead be retrieved, in whole or in part, from a database. For example, instead of receiving the employer information necessary for the generation of an employee demographics report from one of the client systems 120, the demographics report module 169e may instead retrieve this information from a database, such as the database 170, where some or all of the employer information was previously stored.

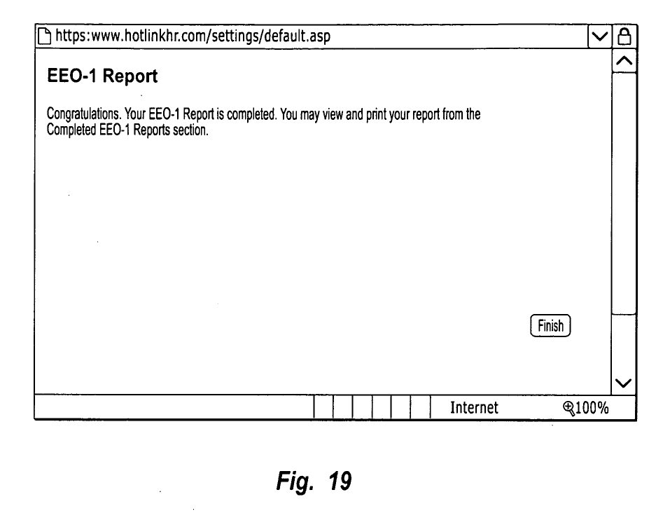

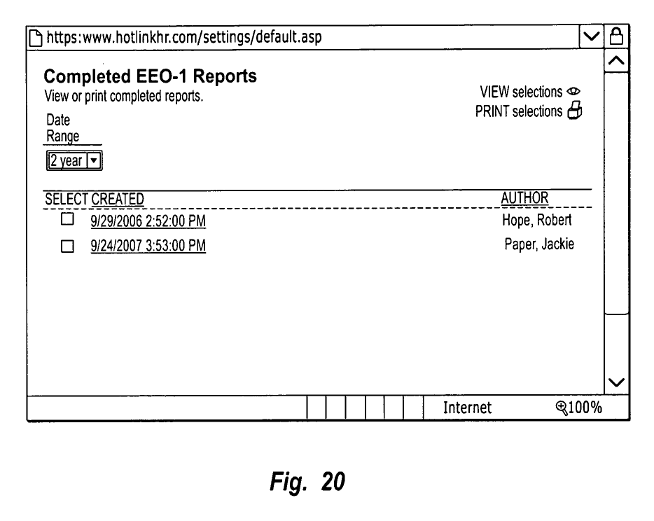

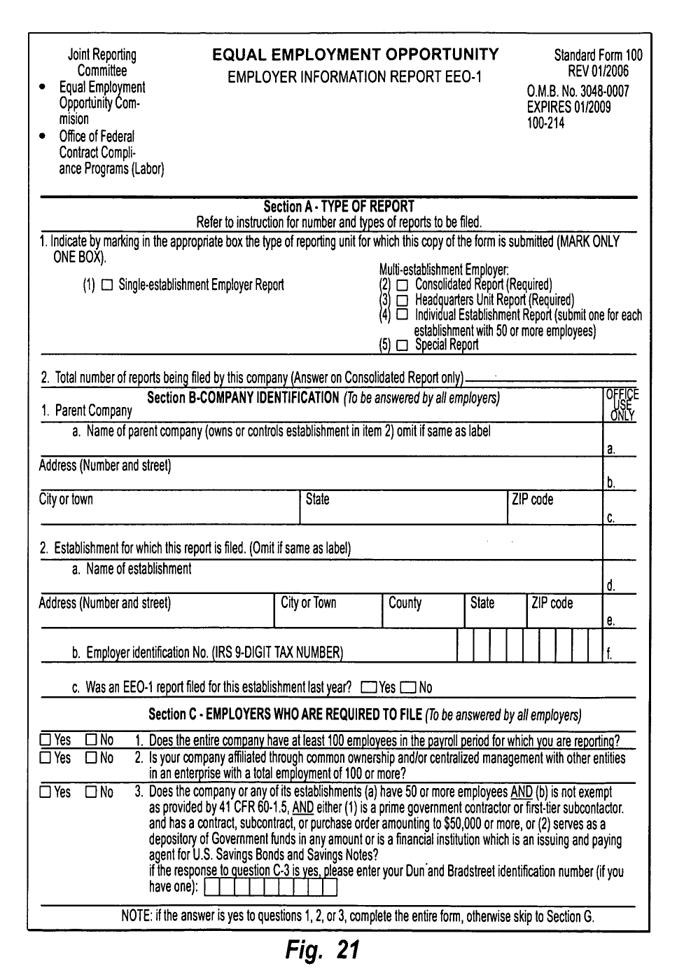

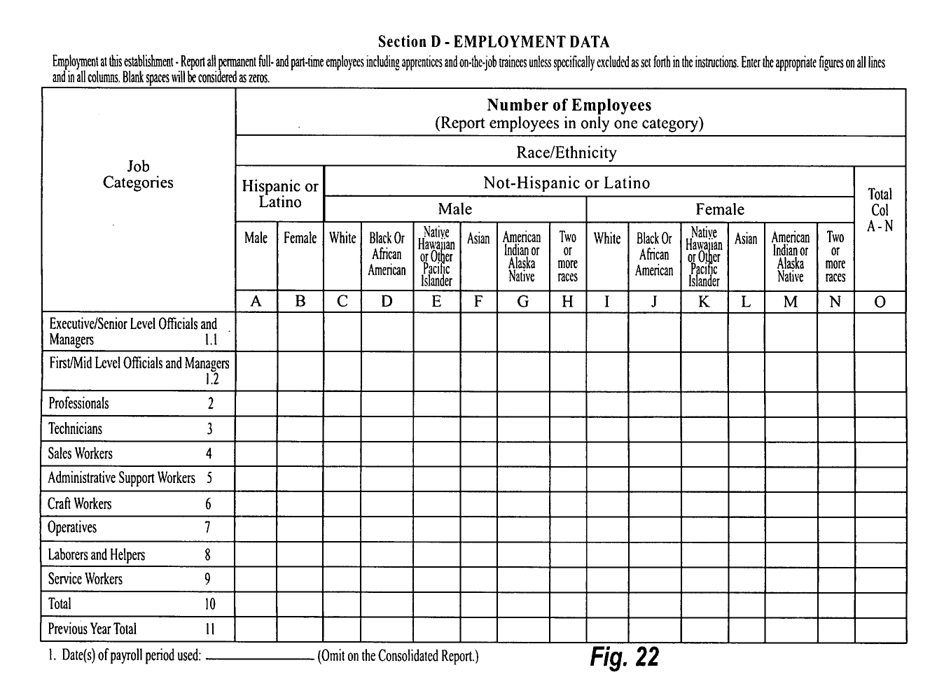

Continuing with the method 500, an employee demographics report is next automatically generated at the server system (act 514). The employee demographics report will include employee A's demographics and employee B's demographics. The employee demographics report may also include employer information, as disclosed above. Next, the server system sends the employee demographics report to the employer client system (act 516) and the employee demographics report is received at the employer client system (act 518), at which point the method 500 terminates. For example, the demographics report module 169e may generate the example employee demographics report disclosed in FIGS. 21 and 22 and send the employee demographics report to the client system 120. The demographics report module 169e may further notify the report coordinator that the employee demographics report is complete and ready to print using the example display of FIG. 19, for example. The demographics report module 169e may further grant access to the report coordinator to all completed employee demographics reports using the example display of FIG. 20, for example. The report coordinator may then file the report with the appropriate government agency in any manner including those disclosed elsewhere herein, for example.

Thus, the example method 500 disclosed herein may facilitate the gathering of employee demographics from employees, the gathering and/or entry of employer information, and the generation of the employee demographics reports.

### 7. Fourth Example Method

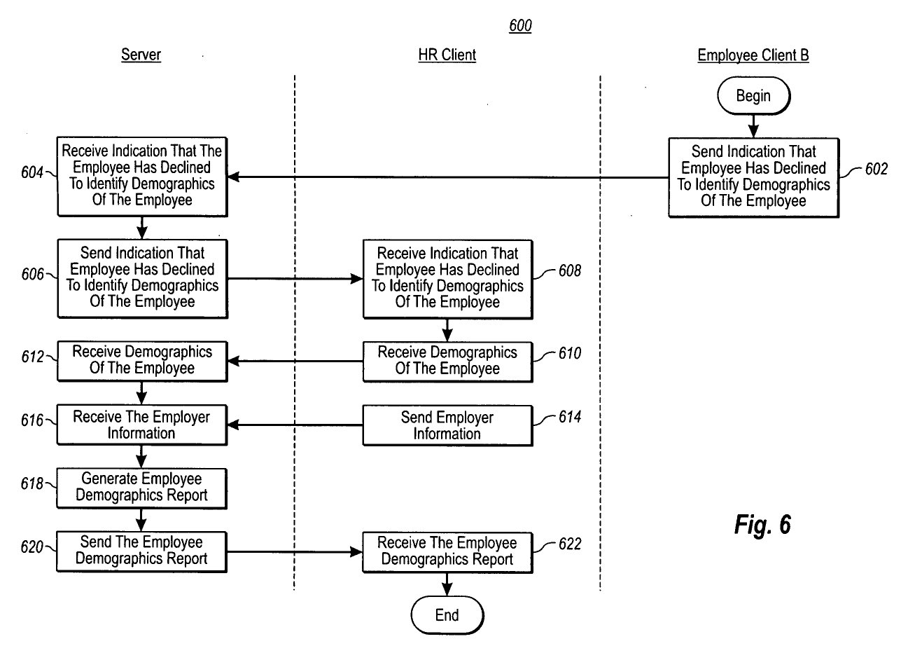

With particular reference now to FIG. 6, additional details regarding the example method 600 for employee demographics reporting compliance will be disclosed. The example method 600 may assist, for example, a human resources administrator of an employer in gathering data and filling in missing data in order to automatically generate an employee demographics report to be filed.

The method 600 begins with an employee client system sending an indication to the server system that an employee has declined to identify demographics of the employee (act 602), and the indication being received at the server system (act 604). For example, at act 602, one of the client systems 120 can send an indication to the demographics report module 169e of the server system 110 that an employee has declined to identify demographics about the employee. This refusal by an employee to identify demographics of the employee can be accomplished by an employee from the privacy of his own employee client system, such as a browser-based application on the employee's own personal computer. For example, the employee can select the “Decline” button on the example display of FIG. 13, for example.

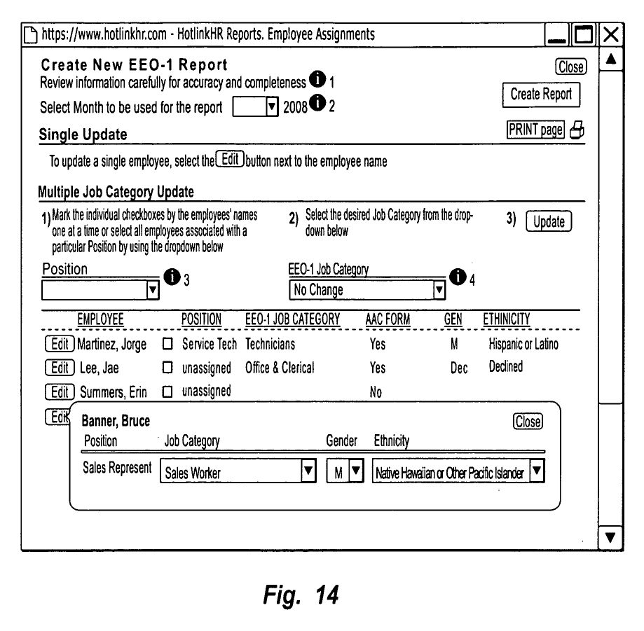

Next, the server system sends an indication to an employer client system that the employee has declined to identify demographics of the employee (act 606) and the indication is received at the employer client system (act 608). The employer client system may then display this indication to a human resources administrator. For example, the indication can be displayed to the human resources administrator on an employer client system, such as a browser-based application on an employer-provided computer. For example, the “dec” or “declined” notation next to the name of an employee in the example display of FIG. 14 A may indicate that the employee has declined to identify demographics of the employee.

Continuing with the example method 600, the employer client system then sends demographics of the employee to the server system (act 610) and the demographics are received at the server system (612). These demographics may be entered by an employer by selecting the edit button on the display disclosed on page 8, and then entering the demographics information into the pop-up window corresponding to the employee.

Continuing with the method 600, the employer client system may next optionally send employer information to the server system (act 614) and the information is received at the server system (act 616). The acts 614 and 616 may be accomplished in a similar manner as the acts 510 and 512 disclosed above. Alternatively, the employer information may instead be retrieved, in whole or in part, from a database, as disclosed above.

Next, an employee demographics report is automatically generated at the server system (act 618). The employee demographics report generated at act 618 will include the demographics of the employee that were identified, not by the employee, but by the employer, as disclosed above. The employee demographics report may also include employer information, as disclosed above. Then, the server system sends the employee demographics report to the employer client system (act 620) and the employee demographics report is received at the employer client system (act 622), at which point the method 600 terminates. For example, the demographics report module 169e may generate the example employee demographics report of FIGS. 21 and 22 and send the employee demographics report to the client system 120. The demographics report module 169e may further notify the report coordinator that the employee demographics report is complete and ready to print using the example display of FIG. 19, for example. The demographics report module 169e may further grant access to the report coordinator to all completed employee demographics reports using the example display of FIG. 20, for example. The report coordinator may then file the report with the appropriate government agency, for example.

Thus, the example method 600 disclosed herein may facilitate the notification of an employer that an employee has declined to provide demographics, the gathering of employee's demographics from an employer, the entry or gathering of employer information, and the generation of the employee demographics reports.

Therefore, the example methods disclosed herein facilitate among other things the determination that an employee demographics report is required, the identification of a report coordinator, the gathering of employee demographics from employees, the notification that an employee has declined to provide demographics, the entry of employee demographics by employers, the gathering and/or entry of employer information, and the generation of the employee demographics report. These example methods can help ease the burden on human resources departments in determining whether to file an employee demographics report and in generating the report in the event that a report is required. The example methods disclosed herein also enable sensitive demographics information to be gathered without a face-to-face conversation between an employee and a report coordinator. An employee can either identify or decline to identify sensitive and personal demographics information from the privacy of his own client system, such as a browser-based application on the employee's own personal computer. These demographics can therefore be gathered without discomfort or unnecessary legal liability.

The example embodiments disclosed herein may be embodied in other specific forms. The example embodiments disclosed herein are to be considered in all respects only as illustrative and not restrictive.

What is claimed is:

1. In a client-server environment, a human resources method for employee demographics reporting compliance, the method comprising the following acts:
a) sending, to a client system, one or more employee demographics reporting criteria;
b) receiving, from the client system, an indication that one or more employee demographics reporting criteria are satisfied;
c) automatically determining that a report coordinator is not yet designated; and
d) sending, to the client system, an indication that a report coordinator must be designated before an employee demographics report can be generated.

2. The method as recited in claim 1, wherein the act b) comprises receiving, from the client system, an indication that one or more of the following reporting criteria are satisfied:
an entire employer has at least a predetermined number of employees in the payroll period for which the employer is reporting;
the employer is affiliated through common ownership and/or centralized management with other entities in an enterprise with a total employment of 100 or more; or
the employer or any of its establishments have a predetermined number of or more employees and either (1) is a prime government contractor or first-tier subcontractor, and has a contract, subcontract, or purchase order amounting to a predetermined amount or more, or (2) serves as a depository of Government funds in any amount or is a financial institution which is an issuing and paying agent for U.S. Savings Bonds and Savings Notes.

3. The method as recited in claim 1, further comprising the following act:
e) receiving, from the client system, an indication that an employee has been designated as a report coordinator.

4. In a client-server environment, a human resources method for employee demographics reporting compliance, the method comprising the following acts:
a) sending, to a client system, one or more employee demographics reporting criteria;
b) receiving, from the client system, an indication that one or more employee demographics reporting criteria are satisfied;
c) automatically determining that an employee demographics report has not yet been filed; and
d) sending, to the client system, an indication that an employee demographics report must be filed.

5. The method as recited in claim 4, wherein the act d) sending, to the client system, an indication that an employee demographics report must be filed by a specific date.

6. In a client-server environment, a human resources method for employee demographics reporting compliance, the method comprising the following acts:
a) receiving, from a first client system, one or more demographics of a first employee;
b) receiving, from a second client system, one or more demographics of a second employee;
c) automatically generating an employee demographics report comprising the one or more demographics of the first and second employees; and
d) sending, to a third client system, the employee demographics report.

7. The method as recited in claim 6, further comprising the following act:
b.1) receiving, from the third client system, employer information.

8. The method as recited in claim 7, wherein the employer information comprises at least one of employer name, employer address, whether an employee demographics report was filed by the employer in the previous year, the employer business, an employer identification number, an employee to contact regarding the employee demographics report, an address of the employee to contact regarding the employee demographics report, or a telephone number of the employee to contact regarding the employee demographics report.

9. The method as recited in claim 7, wherein the employee demographics report further comprises the employer information.

10. The method as recited in claim 6, further comprising the following act:
b.1) retrieving, from a database, employer information from the third client system.

11. The method as recited in claim 10, wherein the employee demographics report further comprises the employer information.

12. The method as recited in claim 6, further comprising the following act:
b.1) receiving, from the third client system, one or more demographics of a third employee.

13. The method as recited in claim 12, wherein the employee demographics report further comprises the one or more demographics of the third employee.

14. The method as recited in claim 6, wherein the employee demographics include at least one of employee gender, employee race, or employee ethnicity.

15. In a client-server environment, a human resources method for employee demographics reporting compliance, the method comprising the following acts:
a) receiving, from a first client system, an indication that an employee has declined to identify one or more demographics of the employee;
b) sending, to a second client system, an indication that the employee has declined to identify one or more demographics of the employee;
c) receiving, from the second client system, one or more demographics of the employee;
d) automatically generating an employee demographics report comprising the one or more demographics of the employee; and
e) sending, to the second client system, the employee demographics report.

16. The method as recited in claim 15, wherein the employee demographics include at least one of employee gender, employee race, or employee ethnicity.

17. The method as recited in claim 15, further comprising the following act:
c1) receiving, from the second client system, employer information to be included in the employee demographics report.

18. In a client-server environment, a human resources method for employee demographics reporting compliance, the method comprising the following acts:
a) receiving, from a server system, one or more employee demographics reporting criteria;
b) determining that one or more of the employee demographics reporting criteria is satisfied; and
c) sending, to the server system, an indication that one or more employee demographics reporting criteria is satisfied.

19. The method as recited in claim 18, further comprising the following acts:
d) receiving, from the server system, an indication that a report coordinator must be specified;
e) receiving, from a user, an indication specifying a report coordinator; and
f) sending, to the server system, an indication that a report coordinator has been specified.

20. The method as recited in claim 18, further comprising the following acts:
d) receiving, from the server system, an indication that an employee demographics report must be filed;
e) receiving, from a user, an indication that an employee demographics report has been filed; and
f) sending, to the server system, an indication that the employee demographics report has been filed.
